(19) United States
(12) Patent Application Publication
(10) Pub. No.: US 2024/0274382 A1
(43) Pub. Date: Aug. 15, 2024

(54) MULTI-DIRECTIONAL INPUT DEVICE

(71) Applicant: ALPS ALPINE CO., LTD., Tokyo (JP)

(72) Inventor: Nobuyuki NINOMIYA, Miyagi (JP)

(21) Appl. No.: 18/642,390

(22) Filed: Apr. 22, 2024

Related U.S. Application Data
(63) Continuation of application No. PCT/JP2022/039041, filed on Oct. 20, 2022.

(30) Foreign Application Priority Data
Nov. 2, 2021 (JP) 2021-179502

(51) Int. Cl. H01H 25/04; G05G 9/047

(52) U.S. Cl. CPC H01H 25/04; G05G 9/047; G05G 2009/04755; G05G 2009/04759

(57) ABSTRACT

A multi-directional input device including: an operating member; a first co-functioning member with a first rotating axis; a second co-functioning member with a second rotating axis; a first slider moving in a first horizontal direction following rotation of the first co-functioning member; a second slider moving in a second horizontal direction following rotation of the second co-functioning member; a first generating member generating a first physical field; a second generating member generating a second physical field; a first detection part detecting movement of the first generating member by detecting the first physical field; and a second detection part detecting movement of the second generating member by detecting the second physical field, and, one from among the first and second generating members is positioned further away from the other one than is the rotating axis that rotates when the one generating member moves.

### CROSS-REFERENCE TO RELATED APPLICATION

The present application is a continuation filed under 35 U.S.C. 111(a) claiming the benefit under 35 U.S.C. 120 and 365 (c) of PCT International Application No. PCT/JP2022/039041 filed on Oct. 20, 2022, and designating the U.S., which is based on and claims priority to Japanese Patent Application No. 2021-179502, filed on Nov. 2, 2021. The entire contents of PCT International Application No. PCT/JP2022/039041 and Japanese Patent Application No. 2021-179502 are incorporated herein by reference.

### BACKGROUND OF THE INVENTION

### 1. Field of the Invention

The present invention relates to a multi-directional input device.

### 2. Description of the Related Art

In multi-directional input devices used for gaming machine controllers and the like, a technique for detecting the angle of the operating shaft (lever) by using variable resistors has long been known. Assuming a multi-directional input device of this sort, a technique for allowing a slider to move according to the tilt of the operating member and a contact held by the slider to slide on a resistance circuit on a substrate, so that resistance values that match the amount of operation of the operating member can be gained, has been created (for example, see patent document 1 below).

### CITATION LIST

### Patent Document

Patent Document 1: Unexamined Japanese Patent Application Publication No. 2001-229782

### SUMMARY OF THE INVENTION

### Technical Problem

However, such conventional multi-directional input devices have the risk of producing wear particles due to the slide of contacts in the resistance circuit. Therefore, instead, a structure in which the amount of a slider's movement is detected by using magnets held in the slider and magnetic sensors mounted on a substrate, may be used. In this case, although wear particles are not produced, when the entire device is made smaller, a first magnet, which slides in a first direction following tilting operations of the operating member in the first direction, and a second magnet, which slides in a second direction following tilting operations of the operating member in the second direction, might be brought close to each other and interfere with each other.

### Solution to Problem

According to one embodiment of the present invention, a multi-directional input device includes:
an operating member that can be operated in a tilting operation;
a first co-functioning member having a first rotating axis, and configured to rotate about the first rotating axis in conjunction with the tilting operation of the operating member;
a second co-functioning member having a second rotating axis that is orthogonal to the first rotating axis, and configured to rotate about the second rotating axis in conjunction with the tilting operation of the operating member;
a first slider configured to move in a first horizontal direction according to rotation of the first co-functioning member;
a second slider configured to move in a second horizontal direction orthogonal to the first horizontal direction, according to rotation of the second co-functioning member;
a first generating member held in the first slider and configured to generate a first physical field targeted for detection;
a second generating member held in the second slider and configured to generate a second physical field targeted for detection;
a first detection part configured to detect an amount of movement of the first generating member by detecting a condition of the first physical field targeted for detection generated by the first generating member; and
a second detection part configured to detect an amount of movement of the second generating member by detecting a condition of the second physical field targeted for detection generated by the second generating member, and,
when viewed from a vertical direction that is orthogonal to a first horizontal direction and a second horizontal direction, one generating member from among the first generating member and the second generating member is positioned further away from the other generating member than is the rotating axis that rotates when the one generating member moves.

### Advantageous Effect of the Invention

According to the multi-directional input device of one embodiment, it is possible to prevent or substantially prevent two generating members from interfering with each other.

### BRIEF DESCRIPTION OF DRAWINGS

FIG. 1 is an outer perspective view of a multi-directional input device according to an embodiment;

FIG. 2 is an outer perspective view of the multi-directional input device according to the embodiment (without a frame);

FIG. 3 is an exploded perspective view of the multi-directional input device according to the embodiment;

FIG. 4 is a cross-sectional view of the multi-directional input device according to the embodiment, taken along an A-A cross-sectional line;

FIG. 5 is a cross-sectional view of the multi-directional input device according to the embodiment, taken along a B-B cross-sectional line;

FIG. 6 is an outer perspective view that illustrates a structure of a part of the multi-directional input device according to the embodiment;

FIG. 7 is a cross-sectional view that illustrates a structure of an engaging part of an actuator in the multi-directional input device according to the embodiment;

FIG. 8 is a cross-sectional view that illustrates a structure of an engaging part of an actuator in the multi-directional input device according to the embodiment;

FIG. 9A is a diagram for explaining an operation that takes place when a lever in the multi-directional input device according to the embodiment tilts in the X-axis direction;

FIG. 9B is a diagram for explaining an operation that takes place when the lever in the multi-directional input device according to the embodiment tilts in the X-axis direction;

FIG. 10A is a diagram for explaining an operation that takes place when the lever in the multi-directional input device according to the embodiment tilts in the X-axis direction;

FIG. 10B is a diagram for explaining an operation that takes place when the lever in the multi-directional input device according to the embodiment tilts in the X-axis direction;

FIG. 10C is a diagram for explaining an operation that takes place when the lever in the multi-directional input device according to the embodiment tilts in the X-axis direction;

FIG. 11A is a diagram for explaining an operation that takes place when the lever in the multi-directional input device according to the embodiment tilts in the Y-axis direction;

FIG. 11B is a diagram for explaining an operation that takes place when the lever in the multi-directional input device according to the embodiment tilts in the Y-axis direction;

FIG. 12A is a diagram for explaining an operation that takes place when the lever in the multi-directional input device according to the embodiment tilts in the Y-axis direction;

FIG. 12B is a diagram for explaining an operation that takes place when the lever in the multi-directional input device according to the embodiment tilts in the Y-axis direction;

FIG. 12C is a diagram for explaining an operation that takes place when the lever in the multi-directional input device according to the embodiment tilts in the Y-axis direction;

FIG. 13 is a view seen form the upward vertical direction, illustrating positioning of magnetic sensors in the multi-directional input device according to the embodiment;

FIG. 14 is an enlarged partial cross-sectional view that illustrates positioning of a first slider in the multi-directional input device according to the embodiment; and

FIG. 15 is an enlarged partial cross-sectional view that illustrates positioning of a second slider in the multi-directional input device according to the embodiment.

### DETAILED DESCRIPTION OF THE PREFERRED EMBODIMENTS

An embodiment of the present invention will be described below with reference to the accompanying drawings.

### Overview of Multi-Directional Input Device 100

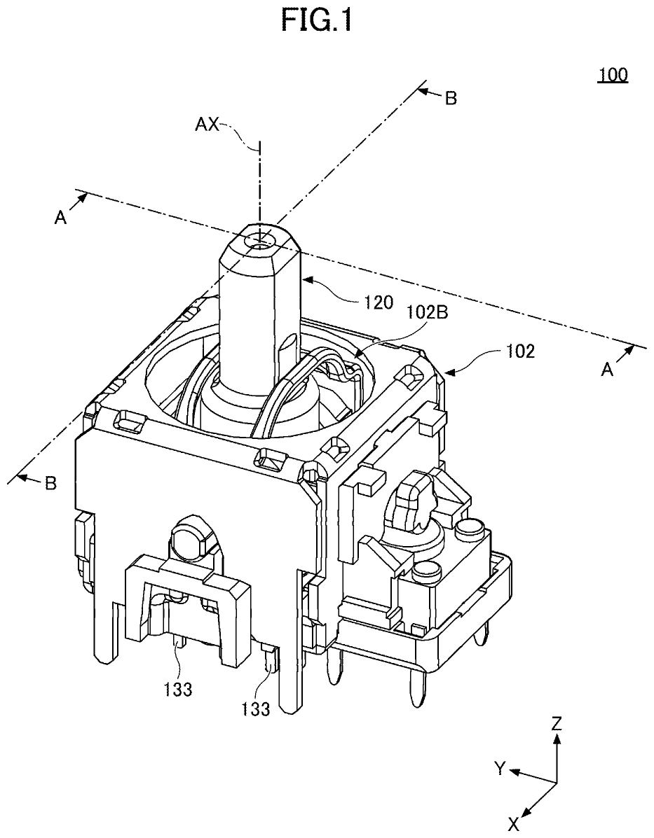

FIG. 1 is an outer perspective view of a multi-directional input device 100 according to an embodiment of the present invention. The multi-directional input device 100 shown in FIG. 1 is used for a controller of a gaming machine or the like. As illustrated in FIG. 1, the multi-directional input device 100 has a columnar lever 120 that extends upward (in the positive Z-axis direction) from an opening 102B of a frame 102 and that can be operated in tilting operations. The lever 120 of the multi-directional input device 100 can be tilted and operated not only in the X-axis direction and the Y-axis direction, but also in all directions between the X-axis direction and the Y-axis direction. Furthermore, the multi-directional input device 100 can output operation signals according to the tilting operation (the tilting direction and tilting angle) of the lever 120, to the outside, via multiple metallic terminals 133.

### Structure of Multi-Directional Input Device 100

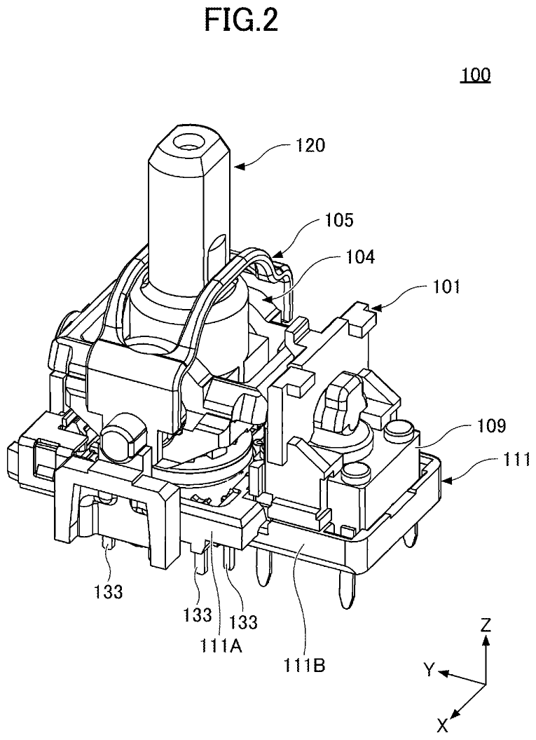

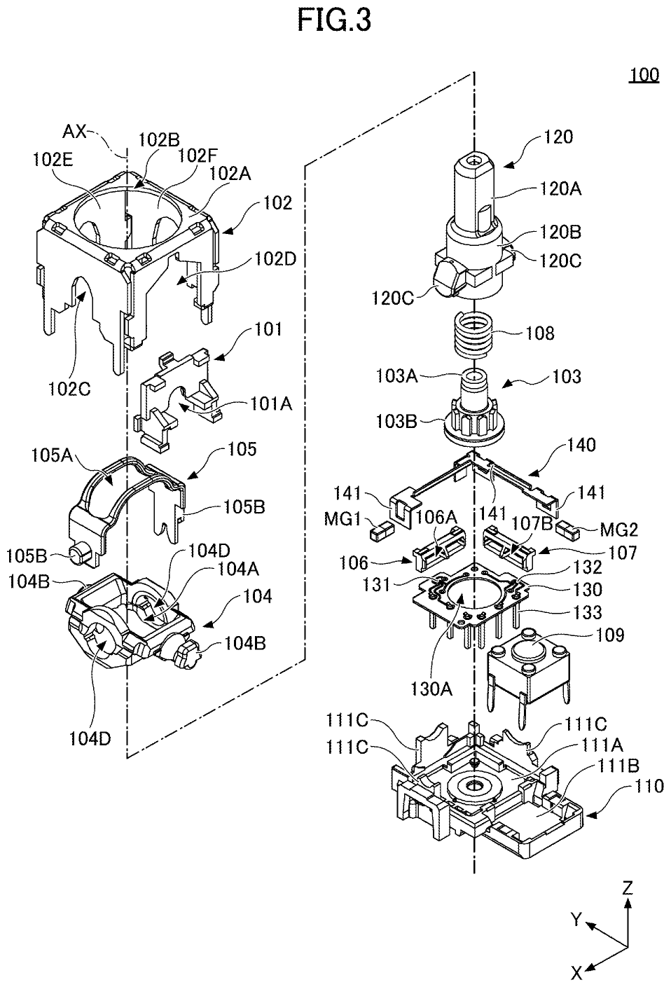

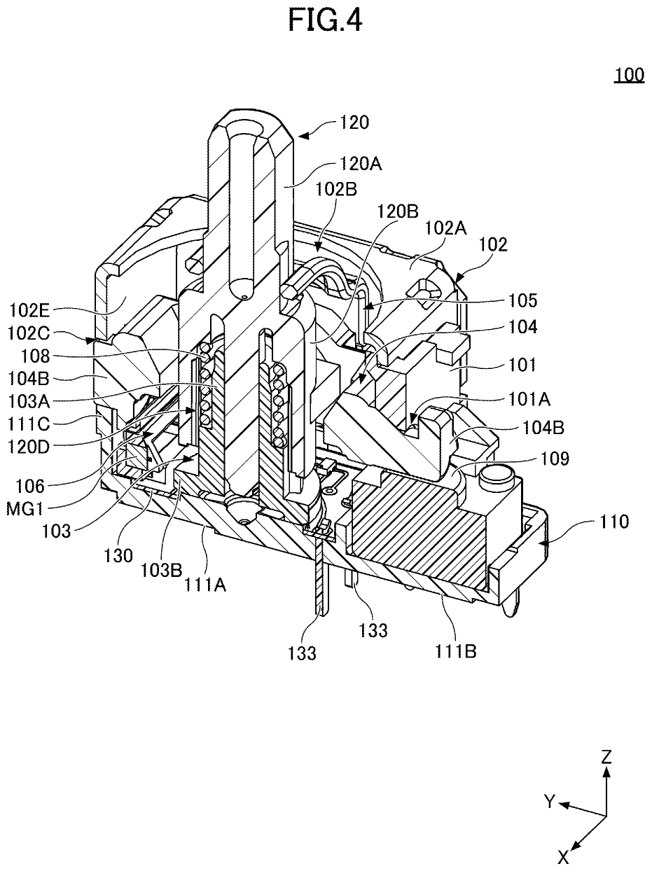

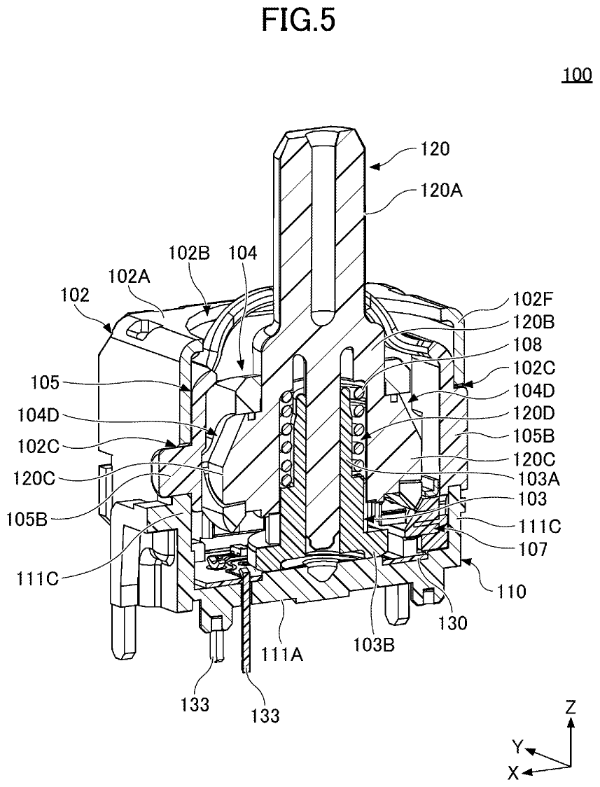

FIG. 2 is an outer perspective view of the multi-directional input device 100 according to the embodiment (without the frame 102). FIG. 3 is an exploded perspective view of the multi-directional input device 100 according to the embodiment. FIG. 4 is a cross-sectional view of the multi-directional input device 100 according to the embodiment, taken along an A-A cross-sectional line. FIG. 5 is a cross-sectional view of the multi-directional input device 100 according to the embodiment, taken along the B-B cross-sectional line.

As illustrated in FIG. 2 to FIG. 5, the multi-directional input device 100 includes a frame 102, a lever 120, a holder 101, a first actuator 104, a second actuator 105, a first slider 106, a second slider 107, a first magnet MG1, a second magnet MG2, an actuator 103, a spring 108, a switch 109, a case 110, a bottom substrate 130, and a frame 140.

The frame 102 is a box-like member that surrounds the components. The frame 102 is formed by processing one metallic plate (a soft magnetic material plate) into a box-like shape (an approximately cubic shape), in which the bottom surface part is open. An opening 102B, round-shaped when viewed from the upward vertical direction, is formed in the upper surface 102A of the frame 102.

The frame 102 has a first wall 102E, which covers the outer side (the positive Y side) of the first slider 106, and a second wall 102F, which covers the outer side (the negative-X-axis side) of the second slider 107. The frame 102 can draw in the first magnet MG1 held in an opening 106A of the first slider 106 by the first wall 102E (see FIG. 3), and prevent or substantially prevent the first magnet MG1 from falling inward (the negative Y side) from the opening 106A of the first slider 106. Also, the frame 102 can draw in the second magnet MG2 held in an opening 107B of the second slider 107 by the second wall 102F (see FIG. 3), and prevent or substantially prevent the second magnet MG2 from falling inward (the positive X side) from the opening 107B of the second slider 107.

The lever 120 is an example of the “operating member,” and is a member that is placed on the center axis AX and subjected to tilting operations by the operator. The lever 120 has an axis 120A and a base 120B. The axis 120A is a part which is generally cylindrical in shape and extends upward from the opening 102B of the frame 102, and on which tilting operations are performed by the operator, directly or indirectly via another member. The base 120B is a part that is generally cylindrical in shape and extends downward from the lower end of the axis 120A. The base 120B supports the lower end of the axis 120A inside the frame 102, and rotates following tilting operations of the axis 120A.

In a cutout 102D formed on the negative-Y-side wall surface of the frame 102, the holder 101, which is a resin member, is inserted from below (from the negative Z side). The holder 101 presses the switch 109 placed in a second part 111B of the case 110 from above, and the semicircular upper end of a support recess 101A presses the negative-Y-side rotating axis 104B of the first actuator 104 from above.

The first actuator 104 is an example of a “first co-functioning member” and is a resin member having a generally rectangular, frame-like shape when viewed from the upward vertical direction. In the first actuator 104, the inner part of its rectangular frame-like shape is an opening 104A. The first actuator 104 has, at both ends thereof in the Y-axis direction, a pair of rotating axes 104B that protrude outward. The rotating axis 104B on the positive-Y-side is held from above and below, between the semicircular upper end of a support recess 102C of the frame 102 and the semicircular upper end surface of a support wall 111C of the case 110. The rotating axis 104B on the negative-Y-side is held from above and below, between the semicircular upper end of a support recess 101A of the holder 101 and the upper surface of a switch 109. Structured thus, the first actuator 104 can rotate in the X-axis direction about the pair of rotating axes 104B. The base 120B of the lever 120 is inserted and placed in the opening 104A. By this means, the first actuator 104 rotates in the

X-axis direction, with the base 120B of the lever 120, following rotation of the lever 120 in the X-axis direction. Also, the first actuator 104 has support holes 104D, which form a pair in the X-axis direction. A pair of projections 120C, which protrude in the X-axis direction from the base 120B of the lever 120, are fitted in the pair of support holes 104D, respectively (see FIG. 5). By this means, the first actuator 104 holds the base 120B of the lever 120 such that the base 120B can rotate in the Y-axis direction.

The second actuator 105 is an example of a “second co-functioning member” and is a member made of resin and having a dome-like shape that is curved upward in a convex manner. The second actuator 105 is placed above the first actuator 104. The second actuator 105 has an opening 105A, which has a rectangular, hole-like shape that extends in the X-axis direction along the curved shape of the second actuator 105. Also, the second actuator 105 has, at both ends thereof in the X-axis direction, a pair of rotating axes 105B that protrude outward. Each of the pair of rotating axes 105B is held from above and below, between the semicircular upper end of a support recess 102C of the frame 102 and the semicircular upper end surface of a support wall 111C of the case 110. Structured thus, the second actuator 105 can rotate in the Y-axis direction about the pair of rotating axes 105B. The axis 120A of the lever 120 is inserted and placed in the opening 105A. By this means, the second actuator 105 rotates in the Y-axis direction, with the axis 120A of the lever 120, following rotation of the lever 120 in the Y-axis direction.

As illustrated in FIG. 2 to FIG. 5, the first actuator 104 and the second actuator 105 are spaced apart so as not to contact each other and overlaid on each other, so that the openings 104A and 105A intersect with each other. Overlaid thus on each other, the first actuator 104 and the second actuator 105 are assembled in the frame 102 with the base 120B, in a state in which the axis 120A of the lever 120 penetrates the opening 104A and opening 105A and the base 120B of the lever 120 is assembled inside.

A first slider 106 holds a first magnet MG1. The first slider 106 has a longitudinal shape that extends in the X-axis direction. The first slider 106 slides in the X-axis direction (an example of the “first horizontal direction”) following the rotation of the first actuator 104, thereby moving the first magnet MG1 in the X-axis direction. The first magnet MG1 is an example of the “first generating member,” shaped like a square bar that extends in the X-axis direction, and exerts a magnetic field (which is an example of a “physical field targeted for detection”). One side of the first magnet MG1 exerts a magnetic field of an N pole and the other side exerts a magnetic field of an S pole, an intermediate point therebetween in the X-axis direction being the boundary.

The second slider 107 holds a second magnet MG2. The second slider 107 has a longitudinal shape that extends in the X-axis direction. The second slider 107 slides in the Y-axis direction (an example of the “second horizontal direction”) following the rotation of the second actuator 105, thereby moving the second magnet MG2 in the Y-axis direction. The second magnet MG2 is an example of a “second generating member,” shaped like a square bar that extends in the Y-axis direction, and exerts magnetic a magnetic field (which is an example of a “physical field targeted for detection”). One side of the first magnet MG2 has a magnetic field of an N pole and the other side has a magnetic field of an S pole, an intermediate point therebetween in the Y-axis direction being the boundary.

The actuator 103 is a resin member with an axis 103A and a bottom disk 103B. The axis 103A, shaped as a rod, is placed on the center axis AX and extends in the vertical direction (the Z-axis direction). The axis 103A is inserted in an opening 120D (see FIG. 4 and FIG. 5) on the bottom side (the negative Z side) of the lever 120. The bottom disk 103B is a disk-like part that is integrated with the lower end of the axis 103A.

The axis 103A of the actuator 103 is inserted in a spring 108, and, in this state, the spring 108 is assembled in the opening 120D on the bottom side (the negative Z side) of the lever 120, with the axis 103A of the actuator 103 (see FIG. 4 and FIG. 5). The spring 108 preloads the lever 120 upward, and preloads the bottom disk 103B of the actuator 103 downward. By this means, when the operator releases a tilting operation of the lever 120, the spring 108 presses the bottom disk 103B of the actuator 103 against the upper surface and the center part of the case 110 and brings the bottom disk 103B back to the horizontal state, thereby allowing the lever 120 to return to the neutral position.

The switch 109 is placed on the upper surface of the second part 111B of the case 110, below the rotating axis 104B positioned on the negative Y side of the first actuator 104. When a downward force is applied to the lever 120, the switch 109 is pressed down by the rotating axis 104B positioned on the negative Y side of the first actuator 104, thereupon switching to the switch-on state.

The case 110, a generally flat member made of resin, is assembled into the bottom surface of the frame 102, so that the bottom surface of the frame 102 is closed. In the case 110, a bottom substrate 130 is placed over the upper surface of the first part 111A centering around the center axis AX. In the case 110, the switch 109 is placed over the upper surface of the second part 111B, which is positioned further in the negative Y-axis direction than the first part 111A is.

The bottom substrate 130 is a flat member made of resin and placed over the upper surface of the first part 111A of the case 110. Magnetic sensors 131 and 132 are mounted on the upper surface of the bottom substrate 130. The first magnetic sensor 131 is positioned so as to face the first magnet MG1. The first magnetic sensor 131 is an example of the “first detection part” and detects a magnetic field according to the position to which the first magnet MG1 slides (that is, according to the tilting angle of the lever 20 in the X-axis direction). The second magnetic sensor 132 is positioned so as to face the second magnet MG2. The second magnetic sensor 132 is an example of the “second detection part” and detects a magnetic field according to the position to which the second magnet MG2 slides (that is, according to the tilting angle of the lever 20 in the Y-axis direction). Also, in the center of the bottom substrate 130, a circular opening 130A that centers around the center axis AX is formed. The bottom disk 103B of the actuator 103 is placed in the opening 130A. Also, on the bottom surface of the bottom substrate 130, multiple metallic terminals 133 for outputting operating signals to the outside according to the tilting operation (the tilting direction and tilting angle) of the lever 120 are provided so as to protrude downward.

The frame 140 is provided above the first slider 106 and the second slider 107, and covers the upper sides of the first slider 106 and the second slider 107. Therefore, the frame 140 is shaped like the letter “L” when viewed from the upward vertical direction. The frame 140 is formed by processing one metallic plate (non-magnetic material plate). The frame 140 has hooks 141 at both ends thereof and near the corner of the letter “L,” and the frame 140 is fixed to the case 110 as these hooks 141 engage with the case 110.

### Structure for Holding First Magnet MG1 and Second Magnet MG2

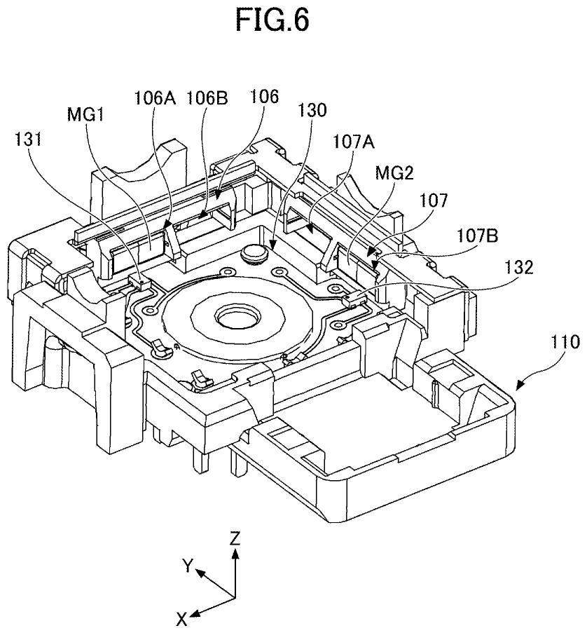

FIG. 6 is an outer perspective view that illustrates a part of the structure of the multi-directional input device 100 according to the embodiment. As illustrated in FIG. 6, the first slider 106 has an opening 106A on the positive X side and an opening 106B on the negative X side. The opening 106A and the opening 106B allow the first slider 106 to pass therethrough in the Y-axis direction, and have a rectangular shape when viewed from the vertical direction from the Y-axis direction, so that the first magnet MG1, shaped substantially the same, can be fit in the opening 106A and the opening 106B. However, according to this embodiment, in order to make the distance from the second magnetic sensor 132 larger, the first magnet MG1 is fitted in the opening 106A, which is positioned further away from the second magnetic sensor 132. By this means, the first magnet MG1 reduces its influence on the second magnetic sensor 132, and is held in the first slider 106 so as to slide in the X-axis direction with the first slider 106. Also, on the upper surface of the bottom substrate 130, a first magnetic sensor 131 is mounted in a position to face the first magnet MG1. The first magnetic sensor 131 magnetically detects the slide of the first magnet MG1 in the X-axis direction.

Also, as shown in FIG. 6, the second slider 107 has an opening 107A on the positive Y side and an opening 107B on the negative Y side. The opening 107A and opening 107B penetrate the second slider 107 in the X-axis direction. The opening 107A and the opening 107B have a rectangular shape when viewed from the vertical direction from the X-axis direction, so that a second magnet MG2, shaped substantially the same, can be fitted in the opening 107A and the opening 107B. However, according to this one embodiment, in order to make the distance from the first magnetic sensor 131 larger, the second magnet MG2 is fitted in the opening 107B, which is positioned further away from the first magnetic sensor 1312. By this means, the second magnet MG2 reduces its influence on the first magnetic sensor 131, and is held in the second slider 107 so as to slide in the Y-axis direction with the second slider 107. Also, on the upper surface of the bottom substrate 130, a second magnetic sensor 132 is mounted in a position to face the second magnet MG2. The second magnetic sensor 132 magnetically detects the slide of the second magnet MG2 in the Y-axis direction.

Note that the first slider 106 and the second slider 107 have the same shape. This allows the first slider 106 and the second slider 107 to use common parts, which then can make their manufacture easy and reduce their manufacturing cost.

### Structure of Engaging Part of First Actuator 104

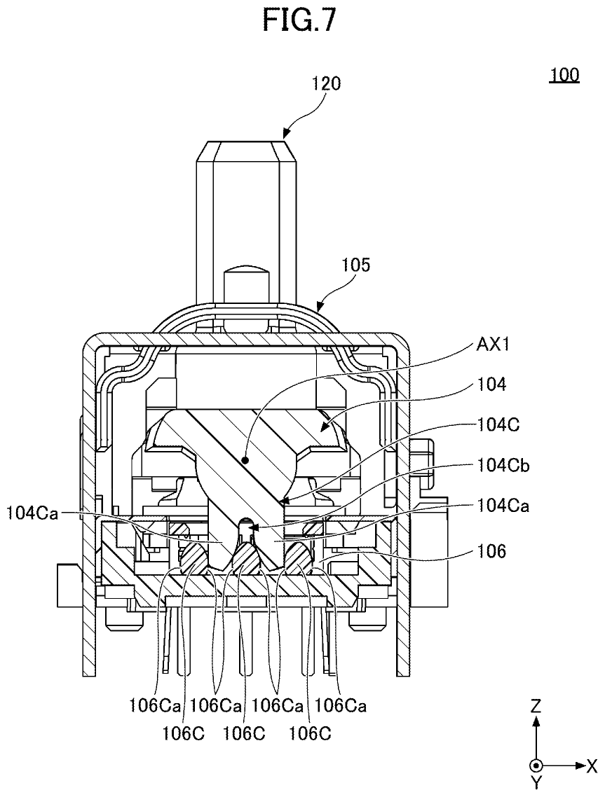

FIG. 7 is a cross-sectional view that illustrates a structure of an engaging part of the first actuator 104 in the multi-directional input device 100 according to the embodiment. As illustrated in FIG. 7, on the outer side surface of the first slider 106, which is provided to be able to slide in the X-axis direction, three gear teeth 106C are provided side by side in the X-axis direction. The three gear teeth 106C are all shaped to protrude upward. In each of the three gear teeth 106C, the side surface 106Ca on the positive X side and the side surface 106Ca on the negative X side are arc-shaped and protrude outward. Meanwhile, the first actuator 104 has an engaging part 104C that protrudes downward from the rotating axis 104B positioned on the negative X side (see FIG. 3). As illustrated in FIG. 7, the engaging part 104C has legs 104Ca that form a pair in the X-axis direction, and that are shaped to be symmetric to each other when viewed from the vertical direction from the positive Y side, with a recess 104Cb formed between the pair of legs 104Ca. In the pair of legs 104Ca, the inner edge 104Cd of each leg 104Ca on the recess 104Cb-side is arc-shaped and protrudes toward the recess 104Cb. The first actuator 104 engages with one of the three gear teeth 106C of the first slider 106, namely the center gear tooth 106C (an example of the “first gear tooth”), between the pair of legs 104Ca. By this means, when the lever 120 is operated to tilt in the X-axis direction, the first actuator 104 rotates in the X-axis direction about the first rotating axis AX1, with the base 120B of the lever 120, and pushes the center gear tooth 106C in the X-axis direction between the pair of legs 104Ca, thereby allowing the first slider 106 to slide in the X-axis direction.

### Structure of Engaging Part of Second Actuator 105

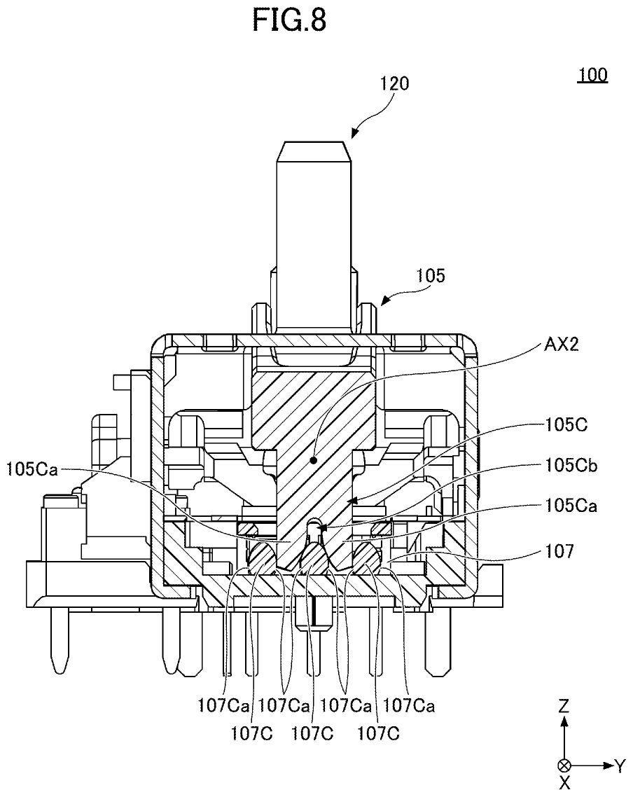

FIG. 8 is a cross-sectional view that illustrates a structure of an engaging part of the second actuator 105 in the multi-directional input device 100 according to the embodiment. As illustrated in FIG. 8, on the outer side surface of the second slider 107, which is provided to be able to slide in the Y-axis direction, three gear teeth 107C are provided side by side in the Y-axis direction. The three gear teeth 107C are all shaped to protrude upward. In each of the three gear teeth 107C, the side surface 107Ca on the positive Y side and the side surface 107Ca on the negative Y side are arc-shaped to protrude outward. Meanwhile, the second actuator 105 has an engaging part 105C that protrudes downward from the rotating axis 105B positioned on the negative X side (see FIG. 3). As illustrated in FIG. 8, the engaging part 105C has legs 105Ca that form a pair in the Y-axis direction, and that are shaped to be symmetric to each other when viewed from the vertical direction from the negative X side, with a recess 105Cb formed between the pair of legs 105Ca. In the pair of legs 105Ca, the inner edge of each leg 105Ca on the recess 105Cb-side is arc-shaped and protrudes toward the recess 105Cb. The engaging part 105C engages with one of the three gear teeth 107C of the second slider 107, namely the center gear tooth 107C (an example of the “first gear tooth”), between the pair of legs 105Ca. By this means, when the lever 120 is operated to tilt in the Y-axis direction, the second actuator 104 rotates in the Y-axis direction about the second rotating axis AX2, with the base 120B of the lever 120, and pushes the center gear tooth 107C in the Y-axis direction between the pair of legs 105Ca, thereby allowing the second slider 107 to slide in the Y-axis direction.

### Operation of Lever 120 When Lever 120 Tilts in the X-Axis Direction

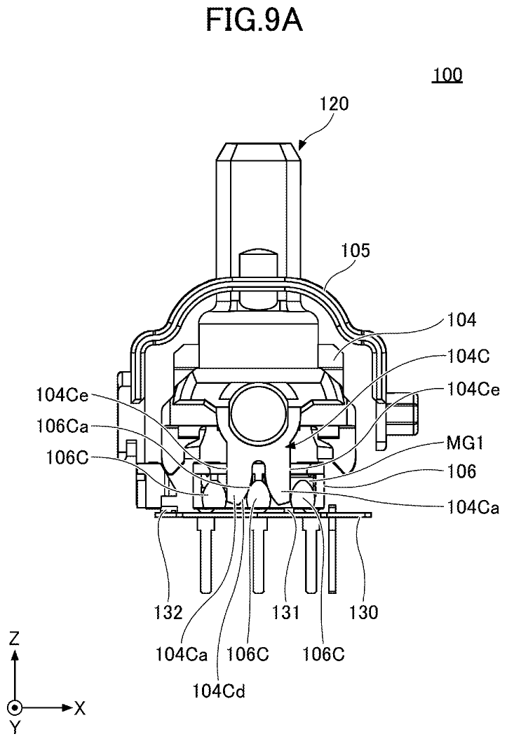

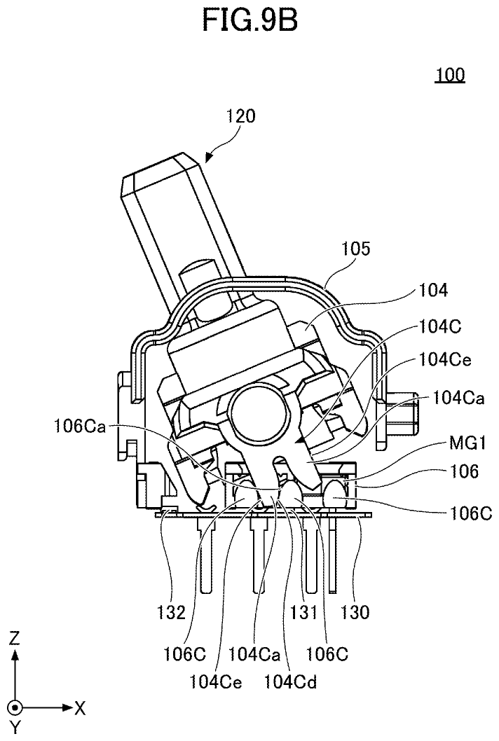

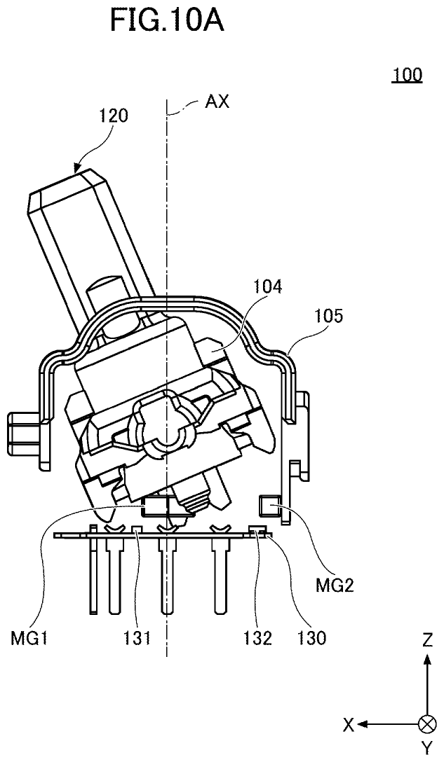

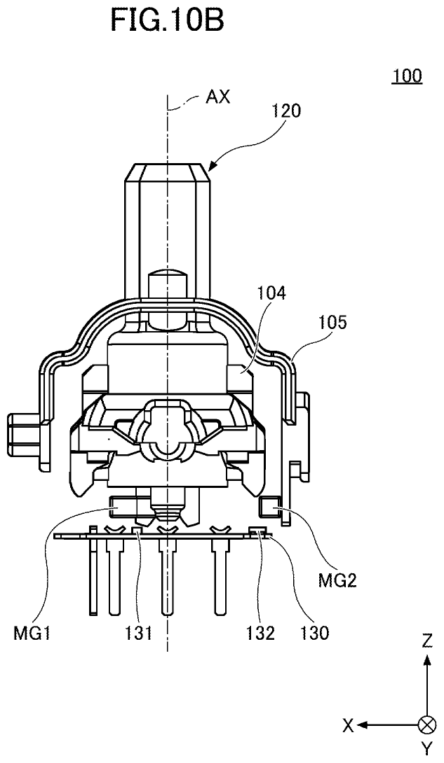

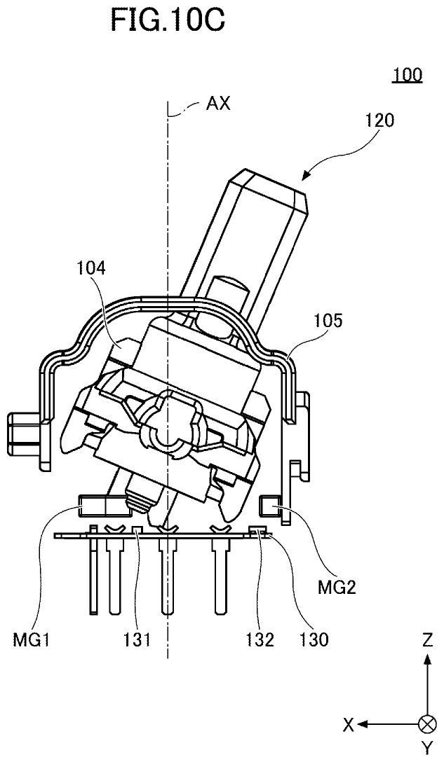

FIGS. 9A and 9B and FIGS. 10A to 10C are diagrams for explaining operations of the lever 120 in the multi-directional input device 100 according to the embodiment when the lever 120 tilts in the X-axis direction.

As illustrated in FIGS. 9A and 9B and FIGS. 10A to 10C, in the multi-directional input device 100 according to the embodiment, when the lever 120 tilts in the X-axis direction, the first slider 106, which engages with the engaging part 104C of the first actuator 104, slides in the X-axis direction following the rotation of the first actuator 104, so that the first magnet MG1 held in the first slider 106 moves in the X-axis direction. When this takes place, the first magnetic sensor 131, which is positioned so as to face the first magnet MG1 on the bottom substrate 130, detects a magnetic field according to the position to which the first magnet MG1 slides (that is, according to the tilting angle of the lever 20 in the X-axis direction). Then, the first magnetic sensor 131 outputs a signal that matches the detected magnetic field, to the outside, as a signal that indicates the tilting angle of the lever 120 in the X-axis direction.

Here, the multi-directional input device 100 according to the embodiment detects the tilting angle of the lever 120 in the X-axis direction in a non-contact manner, by using the first magnetic sensor 131 positioned opposite and distant from the first magnet MG1, so that no sliding contact produces wear particles in the resistance circuit.

Furthermore, the first actuator 104 engages with the center gear tooth 106C among the three gear teeth 106C of the first slider 106, between the pair of legs 104Ca. When the lever 120 tilts in the X-axis direction, between the pair of legs 104Ca of the actuator 104, the leg 104Ca that is positioned on the same side as the side to which the lever 120 is tilted, or the arc-shaped inner edge 104Cd (an example of a “pushing part”) of the leg 104Ca, pushes the arc-shaped side surface 106Ca (an example of a “pushed part”) of the center gear tooth 106C to the side opposite to the side to which the lever 120 is tilted. By this means, the first actuator 104 can allow the first slider 106 to slide opposite to the side to which the lever 120 is tilted. When this takes place, since the inner edge 104Cd of the leg 104Ca and the side surface 106Ca of the center gear tooth 106C that contact each other are both arc-shaped, it is possible to prevent or substantially prevent frictional resistance from being produced between them. In particular, according to this embodiment, the inner edge 104Cd of the leg 104Ca and the side surface 106Ca of the center gear tooth 106C that contact each other are both shaped as arcs along a cycloid curve, so that it is possible to further prevent or substantially prevent frictional resistance from being produced between them.

Also, the outer edges 104Ce, which are each the outer edge of one of the pair of legs 104Ca of the first actuator 104, are planar and extend straight in the vertical direction. By this means, the engaging part 104C of the first actuator 104 allows the mold to be pulled out, from below, during its manufacture, making its manufacture easier.

Note that, when the lever 120 tilted in the X-axis direction returns to its neutral position, between the pair of legs 104Ca of the first actuator 104, the outer edge 104Ce of one leg 104Ca that is positioned on the same side as the side to which the lever 120 is titled, pushes the side surface 106Ca of a gear tooth 106C (an example of a “second gear tooth”) that, among the three gear teeth 106C of the first slider 106, is positioned on the same side as the side to which the lever 120 is tilted, in the direction of return, thus allowing the first slider 106 to slide in the direction of return and the first slider 106 to return to the initial position.

For example, when the lever 120 returns to the neutral position from a state in which it is tilted in the positive X-axis direction, the outer edge 104Ce of the positive-X-side leg 104Ca of the first actuator 104 pushes the side surface 106Ca of a positive-X-side gear tooth 106C of the first slider 106 in the positive X-axis direction, thereby allowing the first slider 106 to slide in the positive X-axis direction and the first slider 106 to return to the initial position.

On the other hand, when the lever 120 returns to the neutral position from a state in which it is tilted in the negative X-axis direction, the outer edge 104Ce of the negative-X-axis-side leg 104Ca of the first actuator 104 pushes the side surface 106Ca of a negative-X-side gear tooth 106C of the first slider 106 in the negative X-axis direction, thereby allowing the first slider 106 to slide in the negative X-axis direction and the first slider 106 to return to the initial position.

The pair of legs 104Ca of the first actuator 104 and the three gear teeth 106C of the first slider 106 constitute what is known as a “rack and pinion mechanism.” Thus, the multi-directional input device 100 according to the embodiment can convert operations in which the lever 120 tilts in the X-axis direction into operations in which the first slider 106 slides in the X-axis direction. Consequently, the relationship between the tilting angle of the lever 120 in the X-axis direction and the distance the first slider 106 moves in the X-axis direction can be made linear (meaning that the two are directly proportional to each other).

### Operation of Lever 120 When Lever 120 Tilts in the Y-Axis Direction

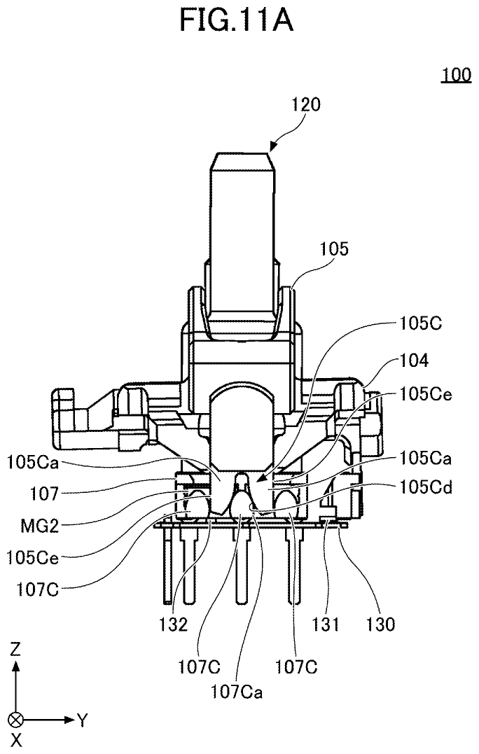

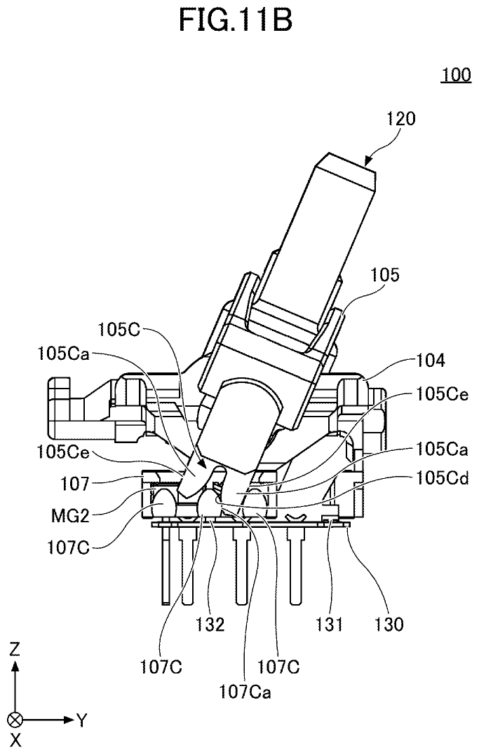

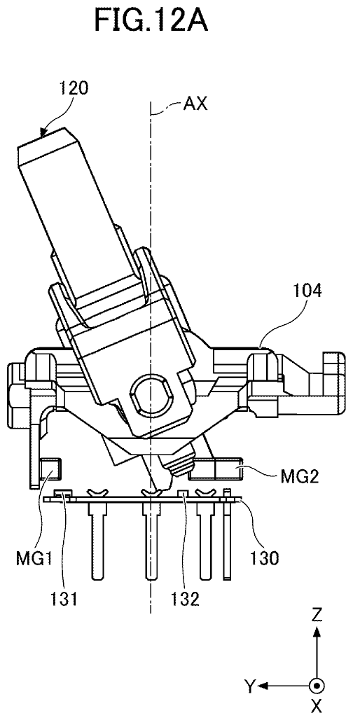

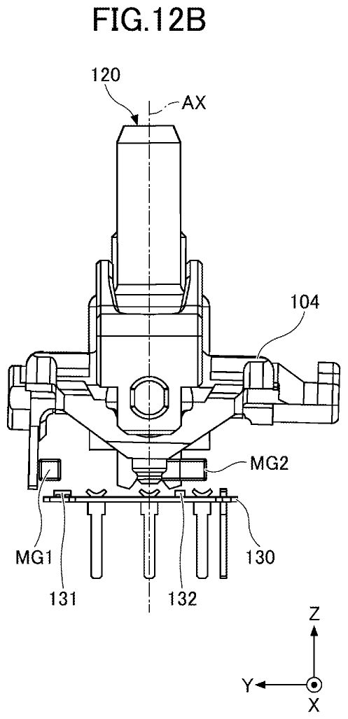

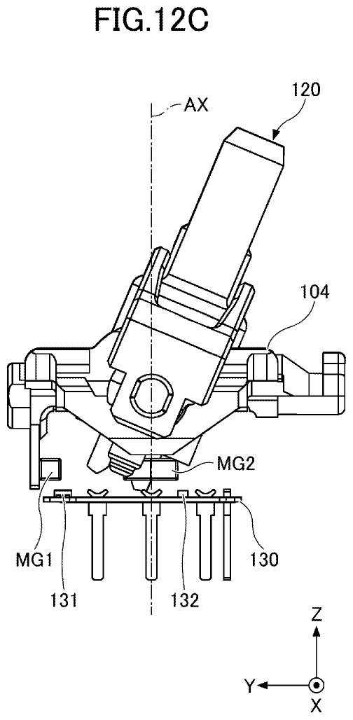

FIGS. 11A and 11B and FIGS. 12A to 12C are diagrams for explaining the operation of the lever 120 in the multi-directional input device 100 according to the embodiment when the lever 120 tilts in the Y-axis direction.

As illustrated in FIGS. 11A and 11B and FIGS. 12A to 12C, in the multi-directional input device 100 according to the embodiment, when the lever 120 tilts in the Y-axis direction, the second slider 107, which engages with the engaging part 105C of the second actuator 105, slides in the Y-axis direction following the rotation of the second actuator 105, so that the second magnet MG2 held in the second slider 107 moves in the Y-axis direction. When this takes place, the second magnetic sensor 132, which is positioned so as to face the second magnet MG2 on the bottom substrate 130, detects a magnetic field according to the position to which the second magnet MG2 slides (that is, according to the tilting angle of the lever 20 in the Y-axis direction). Then, the second magnetic sensor 132 outputs a signal that matches the detected magnetic field, to the outside, as a signal that indicates the tilting angle of the lever 120 in the Y-axis direction.

Here, the multi-directional input device 100 according to the embodiment detects the tilting angle of the lever 120 in the Y-axis direction in a non-contact manner, by using the second magnetic sensor 132 positioned opposite and distant from the first magnet MG2, so that no sliding contact produces wear particles in the resistance circuit.

Furthermore, the second actuator 105 engages with the center gear tooth 107C among the three gear teeth 107C of the second slider 107, between the pair of legs 105Ca. When the lever 120 tilts in the Y-axis direction, between the pair of legs 105Ca of the second actuator 105, the leg 105Ca that is positioned on the same side as the side to which the lever 120 is tilted, or the arc-shaped inner edge 105Cd (an example of a “pushing part”) of the leg 105Ca, pushes the arc-shaped side surface 107Ca (an example of a “pushed part”) of the center gear tooth 107C to the side opposite to the side to which the lever 120 is tilted. By this means, the second actuator 105 can allow the second slider 107 to slide opposite to the side to which the lever 120 is tilted. When this takes place, since the inner edge 105Cd of the leg 105Ca and the side surface 107Ca of the center gear tooth 107C that contact each other are both arc-shaped, these inner edge 105Cd and side surface 107Ca can roll relative to each other, and prevent or substantially prevent frictional resistance from being produced between them. In particular, according to this embodiment, the inner edge 105Cd of the leg 105Ca and the side surface 107Ca of the center gear tooth 107C that contact each other are both arc-shaped along a cycloid curve, so that the inner edge 105Cd and side surface 107Ca can roll relative to each other, and further prevent or substantially prevent frictional resistance from being produced between them.

Also, the outer edges 105Ce, which are each the outer edge of one of the pair of legs 105Ca of the second actuator 105, are planar and extend straight in the vertical direction. By this means, the engaging part 105C of the second actuator 105 allows the mold to be pulled out, from below, during its manufacture, making its manufacture easier.

Note that, when the lever 120 tilted in the Y-axis direction returns to its neutral position, between the pair of legs 105Ca of the second actuator 105, the outer edge 105Ce of one leg 105Ca that is positioned on the same side as the side to which the lever 120 is titled, pushes the side surface 107Ca of a gear tooth 107C (an example of a “second gear tooth”) that, among the three gear teeth 107C of the second slider 107, is positioned on the same side as the side to which the lever 120 is tilted, in the direction of return, thus allowing the second slider 107 to slide in the direction of return and the second slider 107 to return to the initial position.

For example, when the lever 120 returns to the neutral position from a state in which it is tilted in the positive Y-axis direction, the outer edge 105Ce of the positive-Y-side leg 105Ca of the second actuator 105 pushes the side surface 107Ca of a positive-Y-side gear tooth 107C of the second slider 107 in the positive Y-axis direction, thereby allowing the second slider 107 to slide in the positive Y-axis direction and the second slider 107 to return to the initial position.

On the other hand, when the lever 120 returns to the neutral position from a state in which it is tilted in the negative X-axis direction, the outer edge 105Ce of the negative-Y-axis-side leg 105Ca of the second actuator 105 pushes the side surface 107Ca of a negative-Y-side gear tooth 107C of the second slider 107 in the negative Y-axis direction, thereby allowing the second slider 107 to slide in the negative Y-axis direction and the second slider 107 to return to the initial position.

The pair of legs 105Ca of the first actuator 105 and the three gear teeth 107C of the second slider 107 constitute what is known as a “rack and pinion mechanism.” Thus, the multi-directional input device 100 according to the embodiment can convert operations in which the lever 120 tilts in the Y-axis direction into operations in which the second slider 107 slides in the Y-axis direction. Consequently, the relationship between the tilting angle of the lever 120 in the Y-axis direction and the distance the second slider 107 moves in the Y-axis direction can be made linear (meaning that the two are directly proportional to each other).

### Positioning of Magnetic Sensors 131 and 132

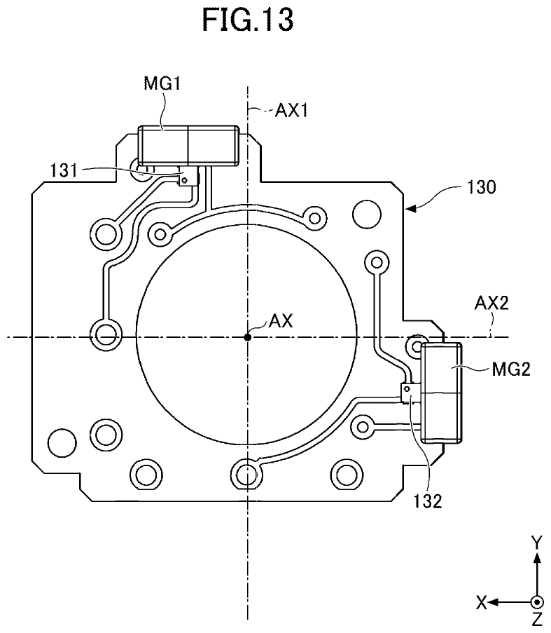

FIG. 13 is a view seen from the upward vertical direction, illustrating positioning of the magnetic sensors 131 and 132 in the multi-directional input device 100 according to the embodiment.

As illustrated in FIG. 13, the first actuator 104 has a first rotating axis AX1 that extends in the Y-axis direction, and rotates about the first rotating axis AX1 according to the tilt of the lever 120 in the X-axis direction. Also, the second actuator 105 has a second rotating axis AX2 that extends in the X-axis direction and is orthogonal to the first rotating axis AX1, and rotates about the second rotating axis AX2 according to the tilt of the lever 120 in the Y-axis direction.

As illustrated in FIG. 6, the first magnet MG1 is fitted in the opening 106A, which is positioned on the positive-X side in the first slider 106. By this means, as shown in FIG. 13, the first magnet MG1 is held by the first slider 106, at a position that is shifted further in the positive X-axis direction than where the first rotating axis AX1 is. In accordance with this, the first magnetic sensor 131 is placed on the upper surface of the bottom substrate 130, at a position that is shifted further in the positive X-axis direction than where the first rotating axis AX1 of the first actuator 104 is. That is, the first magnetic sensor 131 and the first magnet MG1 are positioned so as to face each other, at positions that are shifted further in the positive X-axis direction than where the first rotating axis AX1 is, and at positions where the distance from the second magnet MG2 to the first magnetic sensor 131 is further increased.

Also, as shown in FIG. 6, the second magnet MG2 is fitted in the opening 107B, which is positioned on the negative Y side in the second slider 107. By this means, as shown in FIG. 13, the second magnet MG2 is held by the second slider 107, at a position that is shifted further in the negative Y-axis direction than where the second rotating axis AX2 is. In accordance with this, the second magnetic sensor 132 is placed, on the upper surface of the bottom substrate 130, at a position that is shifted further in the negative Y-axis direction than where the second rotating axis AX2 of the second actuator 105 is. That is, the second magnetic sensor 132 and the second magnet MG2 are positioned so as to face each other, at positions that are shifted further in the negative Y-axis direction than where the second rotating axis AX2 is, and at positions where the distance from the first magnet MG1 to the second magnetic sensor 132 is further increased.

Therefore, according to the multi-directional input device 100 of one embodiment, the distance between: the first magnetic sensor 131 and first magnet MG1; and the second magnetic sensor 132 and second magnet MG2, is greater than in the structure in which the first magnetic sensor 131 and the first magnet MG1 are arranged on the rotating axis AX1, and in which the second magnetic sensor 132 and the second magnet MG2 are arranged on the rotating axis AX2.

By this means, the multi-directional input device 100 according to one embodiment, can reduce the influence that the second magnet MG2 has on the first magnetic sensor 131 and the influence that the first magnet MG1 has on the second magnetic sensor 132.

### Positioning of First Slider 106

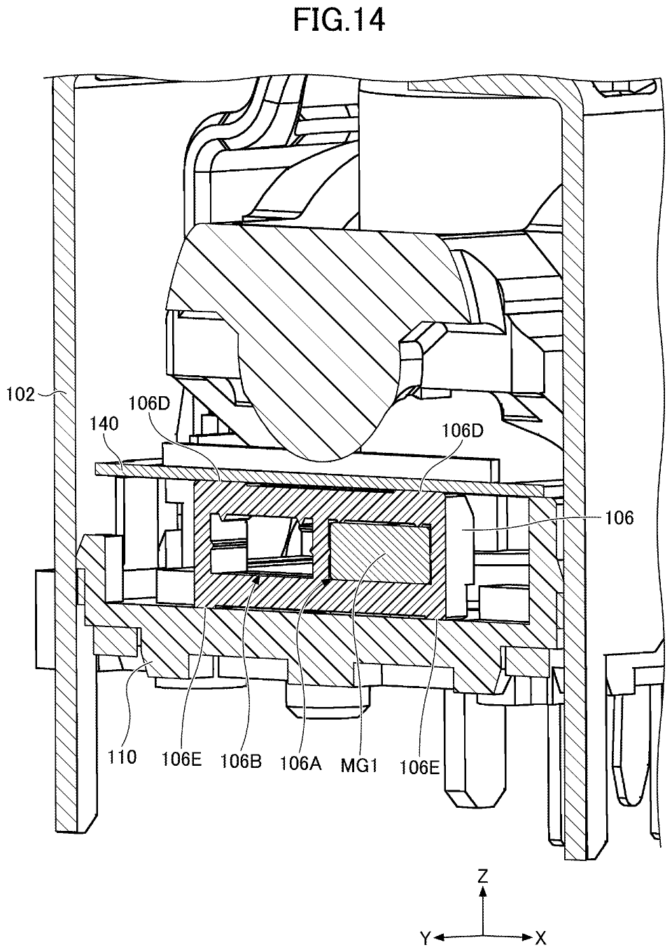

FIG. 14 is an enlarged partial cross-sectional view that illustrates positioning of the first slider 106 in the multi-directional input device 100 according to the embodiment. As illustrated in FIG. 14, the first slider 106 is positioned such that it can slide in the X-axis direction between the frame 140, which is provided above the first slider 106, and the case 110, provided below the first slider 106. The first slider 106 has a slight gap between both the frame 140 and the case 110 and itself, so as not to allow the upper surface and lower surface of the first slider 106 to be in direct contact with the frame 140 and the case 110, respectively. By this means, the multi-directional input device 100 according to this embodiment can prevent or substantially prevent sliding resistance from being produced when the first slider 106 slides. Also, as shown in FIG. 14, the first slider 106 has, on its upper surface, a pair of protrusions 106D formed there with a slight gap between the frame 140 and the protrusions 106D. The pair of protrusions 106E, provided on the lower surface, partly contact the case 110, so that the unsteadiness between the frame 140 and the case 110 can be reduced.

### Positioning of Second Slider 107

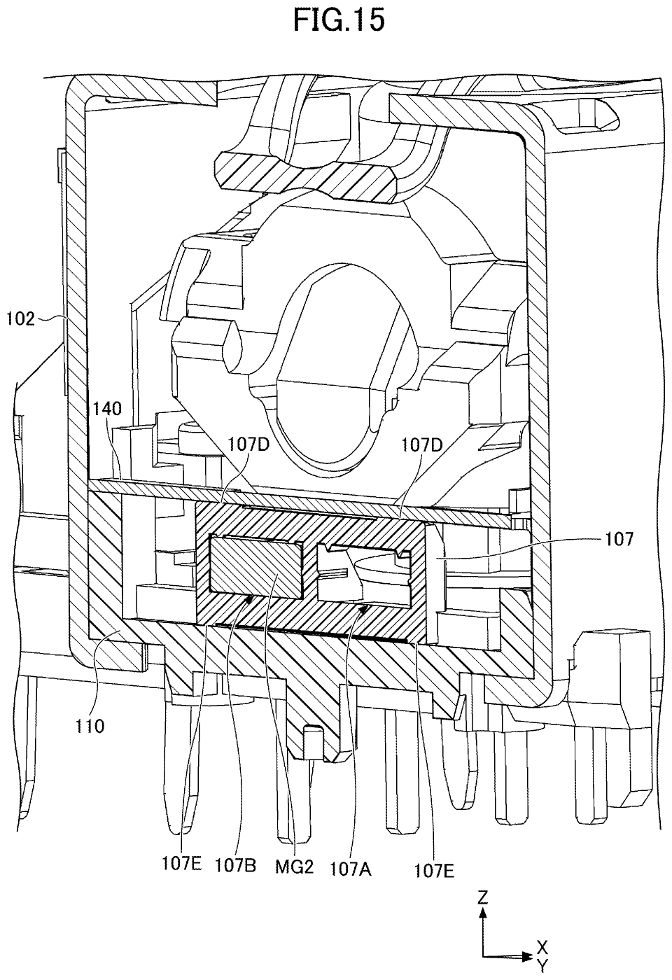

FIG. 15 is an enlarged partial cross-sectional view that illustrates positioning of the second slider 107 in the multi-directional input device 100 according to the one embodiment. As illustrated in

FIG. 15, the second slider 107 is positioned such that it can slide in the Y-axis direction between the frame 140, which is provided above the second slider 107, and the case 110, provided below the second slider 107. The second slider 107 has a slight gap between both the frame 140 and the case 110 and itself, so as not to allow the upper surface and lower surface of the second slider 107 to be in direct contact with the frame 140 and the case 110, respectively. By this means, the multi-directional input device 100 according to this embodiment can prevent or substantially prevent sliding resistance from being produced when the second slider 107 slides. Also, as shown in FIG. 15, the first slider 107 has, on its upper surface, a pair of protrusions 107D formed there with a slight gap between the frame 140 and the protrusions 107D. The pair of protrusions 107E, provided on the lower surface, partly contact the case 110, so that the unsteadiness between the frame 140 and the case 110 can be reduced.

Although an embodiment of the present invention has been described in detail above, the present invention is by no means limited to the details of this embodiment, and various alterations and changes can be made within the scope of the present invention as defined by the claims attached herewith.

For example, according to the embodiment described herein, the “physical field targeted for detection” refers to magnetic field, but this is by no means limiting. For example, the “physical field targeted for detection” may refer to a medium, element, signal, energy, force, and wave that can be transmitted and received, such as light or sound.

1. A multi-directional input device comprising:
an operating member that can be operated in a tilting operation;
a first co-functioning member having a first rotating axis, and configured to rotate about the first rotating axis in conjunction with the tilting operation of the operating member;
a second co-functioning member having a second rotating axis that is orthogonal to the first rotating axis, and configured to rotate about the second rotating axis in conjunction with the tilting operation of the operating member;
a first slider configured to move in a first horizontal direction according to rotation of the first co-functioning member;
a second slider configured to move in a second horizontal direction orthogonal to the first horizontal direction, according to rotation of the second co-functioning member;
a first generating member held in the first slider and configured to generate a first physical field targeted for detection;
a second generating member held in the second slider and configured to generate a second physical field targeted for detection;
a first detection part configured to detect an amount of movement of the first generating member by detecting a condition of the first physical field targeted for detection generated by the first generating member; and
a second detection part configured to detect an amount of movement of the second generating member by detecting a condition of the second physical field targeted for detection generated by the second generating member,
wherein, when viewed from a vertical direction that is orthogonal to a first horizontal direction and a second horizontal direction, one generating member from among the first generating member and the second generating member is positioned further away from the other generating member than is the rotating axis that rotates when the one generating member moves.

2. The multi-directional input device according to claim 1,
wherein, when viewed from the vertical direction, the first generating member is positioned further away from the second generating member than is the first rotating axis, and
wherein, when viewed from the vertical direction, the second generating member is positioned further away from the first generating member than is the second rotating axis.

3. The multi-directional input device according to claim 1, wherein the first physical field and the second physical field are magnetic fields.

4. The multi-directional input device according to claim 3,
wherein the first slider has an opening where the first generating member can be fit from inside,
wherein the second slider has an opening where the second generating member can be fit from inside, and
wherein the multi-directional input device includes:
a first wall that covers outside of the first slider and is configured to attract the first generating member held in the first slider; and
a second wall that covers outside of the second slider and is configured to attract the second generating member held in the second slider.

5. The multi-directional input device according to claim 1, wherein the first physical field and the second physical field are light fields.

6. The multi-directional input device according to claim 1, wherein the first physical field and the second physical field are sound fields.

7. The multi-directional input device according to claim 1,
wherein, when the first co-functioning member rotates in conjunction with the tilting operation of the operating member, the first co-functioning member moves the first slider in the first horizontal direction by pushing an arc-shaped pushed part of the first slider by an arc-shaped pushing part of the first co-functioning member, and
wherein, when the second co-functioning member rotates in conjunction with the tilting operation of the operating member, the second co-functioning member moves the second slider in the second horizontal direction by pushing an arc-shaped pushed part of the second slider by an arc-shaped pushing part of the second co-functioning member.

8. The multi-directional input device according to claim 7, wherein the pushing parts of the first and second co-functioning members and the pushed parts of the first and second sliders include shapes of arcs along a cycloid curve.

9. The multi-directional input device according to claim 7,
wherein the first co-functioning member and the second co-functioning member each have a pair of legs, an inner edge of each leg serving as the arc-shaped pushing part, and
wherein the first slider and the second slider each have a first gear tooth to be placed between the pair of legs, a side surface of each first gear tooth serving as the arc-shaped pushed part.

10. The multi-directional input device according to claim 9, wherein, in the first co-functioning member and the second co-functioning member, each leg has a planar outer edge.

11. The multi-directional input device according to claim 10,
wherein the first slider and the second slider each have a pair of second gear teeth positioned on both outer sides of the pair of legs,
wherein, when the operating member returns from a tilted state to a neutral state, the outer edge of one of the pair of legs of the first co-functioning member pushes the side surfaces of the second gear teeth of the first slider in a direction of return, to move the first slider in the direction of return, the one of the pair of legs being a leg positioned on a same side as a side to which the operating member is tilted, and
wherein, when the operating member returns from the tilted state to the neutral state, the outer edge of one of the pair of legs of the second co-functioning member pushes the side surfaces of the second gear teeth of the second slider in the direction of return, to move the second slider in the direction of return, the one of the pair of legs being a leg positioned on the same side as the side to which the operating member is tilted.

12. The multi-directional input device according to claim 1, wherein the first detection part and the second detection part are placed on a same bottom substrate.

13. The multi-directional input device according to claim 1, wherein the first slider and the second slider have a same shape.
